(19) United States
(12) Patent Application Publication
(10) Pub. No.: US 2011/0289112 A1
(43) Pub. Date: Nov. 24, 2011

(54) DATABASE SYSTEM, DATABASE MANAGEMENT METHOD, DATABASE STRUCTURE, AND STORAGE MEDIUM

(76) Inventors: Junpei Kamimura, Tokyo (JP); Takehiko Kashiwagi, Tokyo (JP)

(21) Appl. No.: 13/144,828

(22) PCT Filed: Jan. 21, 2010
(86) PCT No.: PCT/JP2010/000326

§ 371 Date: Jul. 15, 2011

(30) Foreign Application Priority Data
Jan. 26, 2009 (JP) 2009-014142

(51) Int. Cl. G06F 17/30

(52) U.S. Cl. 707/769; 707/792; 707/E17.014; 707/E17.044

(57) ABSTRACT

Provided is a database system capable of efficiently and rapidly updating data in a database. The database system has a data processing unit that performs, to the database, data processing base on a query. The database includes an identifier table storing data identifiers each having a fixed length and uniquely representing entity data themselves and a conversion table. The conversion table shows a correspondent relationship between the data identifiers and position data each indicating a position of a storage area of the entity data. The conversion table has a metadata area Fidx, and the metadata area Fidx stores a tuple identifier uniquely designating a tuple that stores each of the data identifiers in the identifier table.

### TECHNICAL FIELD

The present invention relates to a database structure and a technique for processing data in a database.

### BACKGROUND ART

A relational database management system (RDBMS) is a system based on a relational model theory proposed by Edgar Frank Codd in 1970, and currently, has been widely used. A relational database (RDB) is a group of plural tables (in other words, relations), and each of the tables has at least one row (tuple) and one column (attribute field). Regarding the RDBMS, Patent Document 1 (Japanese Patent Application Laid-open No. 2005-208757) can be given as a related art document, for example.

However, the general type of RDBMS noticeably reduces its transaction process speed when the amount of data to be processed is huge and the processing load increases. One reason for this is that, in the case where the data length in each row in a table constituting the RDB is variable, calculation time for determining the data reading position increases when the table is searched on a row-by-row basis, as compared with the case where the data length in each row is fixed.

Further, the RDBMS manages data on the row-by-row basis using a key unique to each row so as to rapidly and efficiently perform the large volume of processes on the row-by-row basis. On the other hand, it is difficult for the RDBMS to efficiently perform the large volume of processes on a column-by-column basis. For example, when processing the data on the column-by-column basis, the RDMBS needs to read data in plural rows corresponding to the columns that a query requests, which causes reduction in the processing speed thereof. Further, the RDMBS can write data to a continuous storage area in a memory on the row-by-row basis, and thus, can rapidly access the data on the row-by-row basis. However, when performing a transaction concerning the searching process, comparison operation, summarization operation and the like on the column-by-column basis, the RDBMS frequently accesses data scatteredly stored in the discontinuous plural areas in the memory, thereby possibly reducing the processing speed.

As a database system for efficiently performing the large volume of searching or summarization, a system called a data warehouse (DWH) is used. However, the DWH is configured independently from a core enterprise system, and does not update data (adding of new data, changing of the existing data or deleting of the existing data) in principle. Therefore, the DWH does not have a database structure capable of efficiently updating the data.

There are systems disclosed in Patent Document 2 (Japanese Patent Application Laid-open No. 2000-339390) and Patent Document 3 (WO 00/10103), for example, each of which aims to solve the problems described above concerning the conventional RDBMS and DWH. The database systems disclosed in Patent Documents 2 and 3 employ a database structure in which logical tabular data are converted, for example, into plural information blocks each corresponding to items of gender, age, height and weight. Each of the information blocks includes a value management table (value list) and an array of pointers to the value management table. The pointer arrangement for the value management table refers to an arrangement in which item value numbers corresponding to respective columns in tabular data (namely, pointers for value management data) are stored in the predetermined order of the tabular data (in the order of recorded number).

### RELATED DOCUMENTS

### Patent Documents

Patent Document 1: Japanese Patent Application Laid-open No. 2005-208757
Patent Document 2: Japanese Patent Application Laid-open No. 2000-339390
Patent Document 3: WO No. 2000/10103

### SUMMARY OF THE INVENTION

However, with the database structures disclosed in Patent Document 2 and Patent Document 3, the item value numbers in the value management table are required to be arrange in a predetermined order in order to enhance the speed of data update (for example, update, insert or delete of record). Therefore, when a new item value number is inserted into the value management table at the time of data updating, it is necessary to re-arrange the other existing item value numbers. Further, the array of pointers to the value management table is also required to be updated so as to be consistent with the item value numbers after the re-arrangement. As a result, with the database structures disclosed in Patent Document 2 and Patent Document 3, the data cannot be updated in an efficient, rapid manner. In particular, in the case of frequently updating the data, the processing load becomes extremely large, which significantly reduces the processing speed.

In view of the matters described above, an object of the present invention is to provide a database system, a database management method, a database structure, and a storage medium capable of efficiently and rapidly updating data in a database, and improving the processing speed of the searching and summarizing.

According to the present invention, there is provided a database system including a data storage unit having a database including plural entity data; and, a data processing unit that receives a query, and performs, to the database, data processing based on the received query. In the database system, the database includes an identifier table storing data identifiers each having a fixed length and uniquely representing each of the plural entity data in an area specified by at least one tuple defined in a row direction and at least one attribute field defined in a column direction, and a conversion table showing a correspondent relationship between the data identifiers and position data each indicating a position of a storage area of each of the plural entity data, and, the conversion table has a metadata area for storing a tuple identifier uniquely designating the tuple storing each of the data identifiers in the identifier table.

According to the present invention, there is provided a database structure including plural entity data. The database structure includes an identifier table storing data identifiers each having a fixed length and uniquely representing each of the plural the entity data in an area specified by at least one tuple defined in a row direction and at least one attribute field defined in a column direction, and a conversion table showing a correspondent relationship between the data identifiers and position data each indicating a position of a storage area of each of the plural the entity data, and, the conversion table has a metadata area for storing a tuple identifier uniquely designating the tuple that stores each of the data identifiers in the identifier table.

According to the present invention, there is provided a method of managing a database including a step (a) of receiving a query in connection with the database having plural entity data; and; a step (b) of performing, to the database, data processing based on the received query. In the method of managing a database, the database includes an identifier table storing data identifiers each having a fixed length and uniquely representing each of the plural the entity data in an area specified by at least one tuple defined in a row direction and at least one attribute field defined in a column direction, and a conversion table showing a correspondent relationship between the data identifiers and position data each indicating a position of a storage area of each of the plural the entity data, and, the conversion table has a metadata area for storing a tuple identifier uniquely designating the tuple that stores each of the data identifiers in the identifier table.

According to the present invention, there is provided a computer readable storage medium for storing a computer program that causes a computer to execute a database management process including a process that receives a query in connection with a database including plural entity data; and, a process that performs, to the database, data processing based on the received query. The database includes an identifier table storing data identifiers each having a fixed length and uniquely representing each of the plural the entity data in an area specified by at least one tuple defined in a row direction and at least one attribute field defined in a column direction, and a conversion table showing a correspondent relationship between the data identifiers and position data each indicating a position of a storage area of each of the plural the entity data. Further, the conversion table has a metadata area for storing a tuple identifier uniquely designating the tuple that stores each of the data identifiers in the identifier table.

According to the present invention, it is possible to efficiently and rapidly update the database, and rapidly perform processes such as searching and summarization.

### BRIEF DESCRIPTION OF THE DRAWINGS

The above-described object and other objects of the present invention, and features and advantages of the present invention will be made further clear by the preferred exemplary embodiments described below and the following drawings attached thereto.

FIG. 1 is a functional block diagram illustrating a schematic configuration of a database system according to an exemplary embodiment of the present invention.

FIG. 2 is a flowchart schematically illustrating a process procedure of a transaction processing unit of the database system.

FIG. 3 is a schematic view illustrating an example of a logical structure of a database according to a first exemplary embodiment of the present invention.

FIG. 4 is a diagram schematically illustrating an example of an actual table.

FIG. 5(A) through FIG. 5(C) are diagrams each illustrating a logical data structure of the database.

FIG. 6(A) and FIG. 6(B) are diagrams each schematically illustrating a first modification example of a conversion table in the database according to the first exemplary embodiment.

FIG. 7(A) and FIG. 7(B) are diagrams each schematically illustrating a second modification example of the conversion table in the database according to the first exemplary embodiment.

FIG. 8(A) and FIG. 8(B) are diagrams each schematically illustrating a third modification example of the conversion table in the database according to the first exemplary embodiment.

FIG. 9(A) and FIG. 9(B) are diagrams each schematically illustrating a fourth modification example of the conversion table in the database according to the first exemplary embodiment.

FIG. 10 is a schematic view illustrating a logical structure of a database according to a second exemplary embodiment of the present invention.

FIG. 11 is a diagram illustrating a reference table and an intermediate identifier table constituting the database according to the second exemplary embodiment.

FIG. 12 is a diagram illustrating a reference table and an intermediate identifier table according to a modification example of the second exemplary embodiment.

FIG. 13 is a diagram illustrating a reference table and an intermediate identifier table according to another modification example of the second exemplary embodiment.

### DESCRIPTION OF EMBODIMENTS

Hereinbelow, exemplary embodiments according to the present invention will be described with reference to the drawings.

### [Basic Configuration of Database System 10]

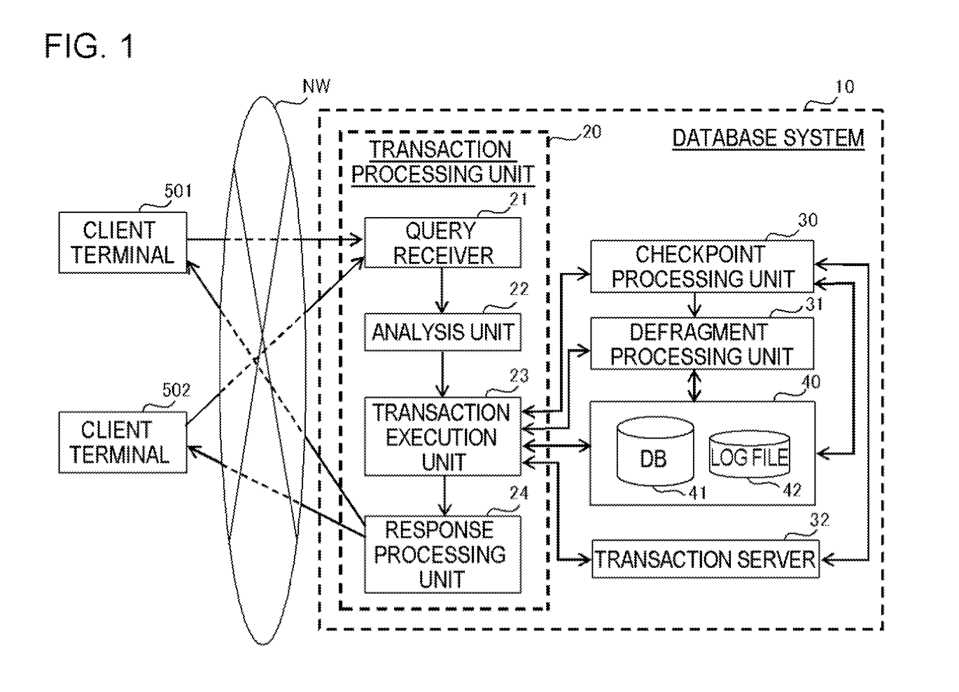

FIG. 1 is a functional block diagram illustrating a schematic configuration of a database system 10 according to an exemplary embodiment of the present invention. The database system 10 includes a transaction processing unit 20, a checkpoint processing unit 30, a defragment processing unit 31, a transaction server 32, and a storage device 40. The storage device 40 stores a database 41 and a log file 42. The transaction processing unit 20 includes a query receiver 21, an analysis unit 22, a transaction execution unit 23, and a response processing unit 24.

The database system 10 and plural client terminals 501, 502 are connected with a network NW. The network NW is, for example, a generally used small-sized network (for example, a wired or wireless LAN), but is not limited to that. The network NW may be a large-sized network such as the Internet.

The client terminals 501, 502 have a function of transmitting, to the database system 10, a query concerning the database 41 and described in a query language (database language) such as a structured query language (SQL) and an XML query language (XQuery).

A hardware configuration of the database system 10 may be a general configuration. The database system 10 may be configured by hardware resources including a processor such as a central processing unit (CPU), a main memory, a cache memory, a signal transmission bus, a timer circuit, an input unit (such as a keyboard and pointing device) and an output unit (such as a display and printer), but is not limited to that.

All or a part of the configuration of the database system 10 may be realized by hardware, or by a computer program (or a program code) that causes the processor to perform processing. In the case where the functions of the constituent elements 21 to 24, 30, 31 and 32 of the database system 10 are realized by the computer program, the processor reads out the computer program from a storage medium such as a nonvolatile memory to execute the program. Further, the constituent elements 21 to 24, 30, 31, 32 and 40 of the database system 10 may be assembled in a single device, or may be assembled decentrally in plural devices that operate in a manner that is linked with each other.

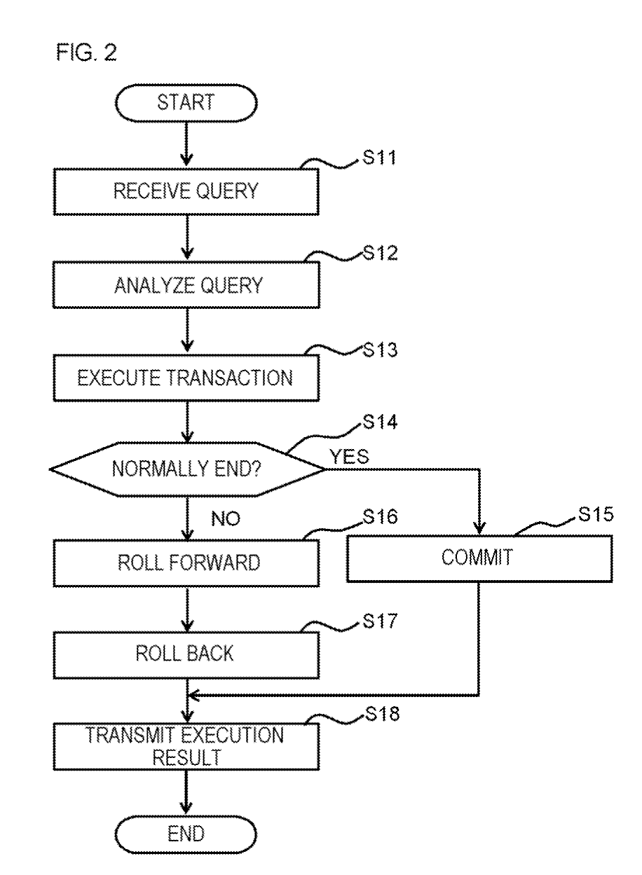

FIG. 2 is a flowchart schematically illustrating a process procedure of the transaction processing unit 20 of the database system 10. In the transaction processing unit 20, the query receiver 21 receives a query coming from the client terminal 501, 502 (step S11), and provides the analysis unit 22 with the received query. The analysis unit 22 analyzes the query (syntactic analysis, optimization process or the like), and provides the transaction execution unit 23 with the results of analysis (step S12). The transaction execution unit 23 executes a transaction based on the results of analysis to the database 41 (step S13). The term transaction as used in this specification refers to a unit of work including a process such as searching and updating of the data base 41, and a process that satisfies the ACID properties, namely, an atomicity, consistency, isolation and durability. If the transaction process normally ends (YES in step S14), the transaction is committed (step S15).

The transaction execution unit 23 records log information (history information) of the transaction as the log file 42 in the storage device 40. In parallel, the transaction execution unit 23 records metadata of a log of the transaction (information on start or end of each transaction and the like) in the transaction server 32.

The checkpoint processing unit 30 periodically sets checkpoints based on the metadata recorded in the transaction server 32 and the log file 42. If the transaction does not normally end due to occurrence of a trouble concerning the transaction or system (NO in step S14 in FIG. 2), the transaction execution unit 23 executes a roll forward (step S16). More specifically, the checkpoint processing unit 30 refers to the log files 42 to check the log information in a period Terr from at the time of the checkpoint most recently set to at point of time when the trouble occurs, and delete, from the log file 42, the log information concerning a transaction that is not committed during the period Terr. Then, if there exists a transaction that is committed during the period Terr, the transaction execution unit 23 reflects, to the database 41, the results of execution of that transaction based on the log file 42. Thereafter, the transaction execution unit 23 returns the database 41 to the state before start of the process of the transaction that is not committed, that is, implements a roll back (step S17).

The response processing unit 24 receives the execution results of the transaction from the transaction execution unit 23, and transmits the received execution results to the client terminal 501, 502 (step S18).

As described later, the database 41 stores a group of entity data including variable length data, and an identifier table storing data identifiers with a fixed length each uniquely representing entity data themselves. A storage area, which is different from the storage area allocated to the identifier table, is allocated to the group of entity data, so that the identifier table and the group of entity data are completely isolated from each other.

In response to the query request, the transaction execution unit 23 searches the data identifiers with the fixed length in the identifier table, without searching the group of entity data. The transaction execution unit 23 uses the searching results to execute transactions such as updating to the database 41.

As the updating of the database 41 is repeatedly performed, record or deletion of the data is also repeatedly performed in the storage device 40. This fragmentizes a group of data recorded in the continuous storage area in the storage device 40 (fragmentation), which reduces the cache hit rate and hence reduces the processing speed. The defragment processing unit 31 has a function of resolving the fragmentation of the data group. More specifically, the defragment processing unit 31 has a function of, when plural data identifiers are stored scatteredly in the discontinuous storage areas in the storage device 40, reading out those data identifiers from the storage device 40, and writing the read out data identifiers to the continuous storage area for the identifier table. For example, when the data identifiers VR11, VR12, VR13 . . . VR19 are stored in the storage areas separated away from each other, the defragment processing unit 31 can write the data identifiers VR11, VR12, VR13, . . . , VR19 to the continuous storage area.

Next, structures of the database 41 according to various exemplary embodiments of the present invention will be described.

### First Exemplary Embodiment

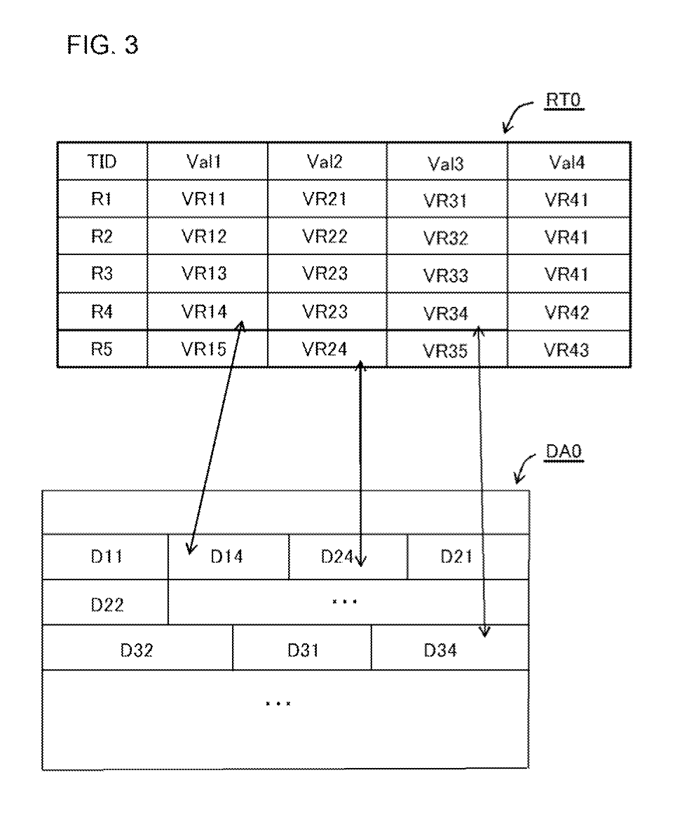

FIG. 3 is a schematic view illustrating an example of a logical structure of the database 41 according to a first exemplary embodiment of the present invention. As illustrated in FIG. 3, the database structure has a group of entity data stored in a storage area DA0 of the storage device 40, and a reference table (identifier table) RT0 stored in a storage area different from the storage area DA0 of the storage device 40.

The reference table RT0 has five tuples defined in the row direction, and five attribute fields TID, Val1, Val2, Val3, Val4 each defined in the column direction. In the first exemplary embodiment, although the number of tuples of the reference table RT0 is set to five for the purpose of facilitating explanation, the number is not limited to that, and the number of tuples may be set, for example, in the range of tens to millions. Further, the number of attribute fields is not limited to five.

Tuple identifiers (TID) R1, R2, R3, R4 and R5 are allocated uniquely to the respective five tuples of the reference table RT0. Each data identifiers VRl1, VRl2, . . . , VR43 with fixed lengths is stored in an area defined by the tuples and the attribute fields Val1, Val2, Val3, Val4 (area at which a tuple intersects an attribute field Val1, Val2, Val3, Val4). More specifically, the attribute field Val1 includes the data identifiers VRl1, VRl2, VRl3, VRl4 and VRl5 in the areas corresponding to the tuple identifiers R1, R2, R3, R4 and R5, respectively; the attribute field Val2 includes the data identifiers VR21, VR22, VR23, VR23 and VR29 in the areas corresponding to the tuple identifiers R1, R2, R3, R4 and R5, respectively; the attribute field Val3 includes the data identifiers VR31, VR32, VR33, VR34 and VR35 in the areas corresponding to the tuple identifiers R1, R2, R3, R4 and R5, respectively; and, the attribute field Val4 includes the data identifiers VR41, VR41, VR41, VR42 and VR43 in the areas corresponding to the tuple identifiers R1, R2, R3, R4 and R5, respectively.

The values of the data identifiers VR11 to VR43 can be obtained by using a hash function. The hash function is a logical operator for outputting a bit stream having a fixed length in response to input of a bit stream having variable lengths. The output values (hash values) of the hash function, which are output in response to input of entity data, can be used as the values of the data identifiers VR11 to VR43. From the viewpoint of ensuring the uniqueness of each of the data identifiers, it is desirable that the anti-collision property of the hash function (property concerning difficulty of generating the same hash value from two different input values) is set to be sufficiently high in accordance with the size of the database 41. The transaction execution unit 23 converts a search string into a hash value, and retrieves, from the reference table RT0, a data identifier having a value that matches the resulting hash value, thereby being able to obtain entity data corresponding to the retrieved data identifier from the storage area DA0. At this time, the transaction execution unit 23 searches the reference table RT0, which does not include the data with a variable length and is formed only by the group of data with fixed lengths, whereby it is possible to rapidly retrieve the string.

The data identifiers VR11 to VR43 described above each have values substantially uniquely representing the respective entity data stored in the storage area DA0. Therefore, the transaction execution unit 23 searches the data identifiers VR11 to VR43, and can access, on the basis of the results of the searching, the entity data with variable lengths, each of which corresponds to each of the data identifiers VR11 to VR43. Note that the term “substantially uniquely” as used in this specification means that uniqueness is satisfied in terms of processing the data in the database 41.

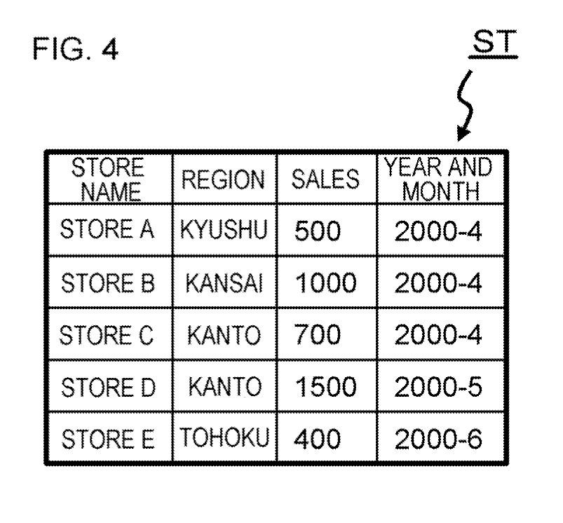

It is possible to set the names of attribute fields Val1, Val2, Val3, Val4 (attribute name), for example, to be “store name,” “region,” “sales” and “year and month.” The database structure illustrated in FIG. 3 may be created on the basis of a group of entity data (entity table) ST as exemplified in FIG. 4. The entity table ST in FIG. 4 is a table with five rows and four column having four attribute fields including “store name,” “region,” “sales,” and “year and month.” The entity data of “store A,” “store B” and “Kyushu” in the entity table ST are subjected to the hash process (converting the values of the entity data into hash values), and the entity data are stored in the storage area DA0, whereby it is possible to generate the data identifiers VR11, VR12, . . . , VR43 with the fixed length illustrated in FIG. 3. Note that the database in the exemplary embodiment can be generated on the basis of the existing entity table, but, is not limited to that. The database structure illustrated in FIG. 3 according to this exemplary embodiment may be generated directly from the input data without generating the entity table.

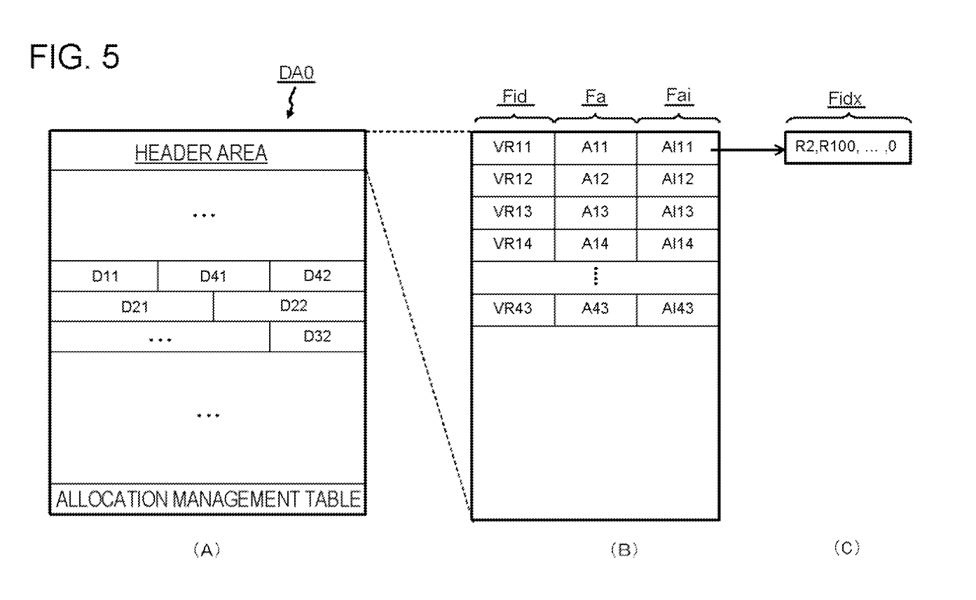

FIG. 5(A) through FIG. 5(C) are diagrams each illustrating a logical data structure constituting the database 41. The data structure illustrated in FIG. 5(A) has a header area at the head portion thereof, and has an allocation management table at the end portion thereof. Further, an area for storing the group of entity data is provided between the header area and the allocation management table.

FIG. 5(B) is a schematic view illustrating an example of a conversion table stored in the header area. The conversion table is a table for specifying the correspondent relationship between the data identifiers VR11 to VR43 and the storage areas of the entity data D11 to D43 corresponding to those data identifiers VR11 to VR43, respectively. As illustrated in FIG. 5(B), the conversion table has areas Fid for storing the data identifiers VR11 to VR43, and an area Fa for storing position data A11 to A43 indicating positions of the storage areas of the entity data D11 to D43 corresponding to those data identifiers VR11 to VR43. Further, the conversion table has areas Fai for storing position data AI11 to A143. The position data AI11 to AI43 indicate positions of the storage areas for the tuple identifiers uniquely indicating the respective tuples storing the data identifiers VR11 to VR43 in the identifier table RT0. FIG. 5(C) is a diagram illustrating a metadata area Fidx storing the tuple identifiers R2, R100 . . . 0 corresponding to the data identifier VR11. The metadata area Fidx is allocated to a storage area, which is different from the storage area DA0.

The position data AI11 to AI43 may be addresses each designating an absolute position of the storage area of each of the tuple identifiers, or be offsets each designating a relative position (effective address) of the storage area on the basis of predetermined addresses. Alternatively, it may be possible to use pointers each indicating an address designated to each of the storage areas as the position data AI11 to AI43.

The conversion table in FIG. 5(B) is formed so as to eliminate the overlap of the data identifiers with the same single value (more specifically, any two data identifiers certainly have different values from each other in the conversion table). Therefore, with the conversion table, it is possible to store entity data having the same value in the storage area DA0 without overlapping the entity data with each other. In other words, a group of entity data constituting the database 41 can be compressed to store it in the storage area DA0, whereby it is possible to efficiently use the storage area DA0. The same applies to the conversion tables in the first modification to the fourth modification, which are described later.

The tuple identifiers stored in the metadata area Fidx are used as index information for the identifier table RT0. The transaction execution unit 23 can access the entity data corresponding to the data identifiers by referring to the header area in FIG. 5(A), and can further obtain all the tuple identifiers associated with the entity data by referring to the metadata area Fidx. More specifically, from the data identifiers, it is possible to identify the group of tuples that store the data identifiers in the identifier table RT0. For example, as illustrated in FIG. 3, plural tuple identifiers R1 to R3 are allocated to the tuples storing the data identifier VR41. With the conversion table in FIG. 5(B), it is possible to collectively identify the tuple identifiers R1 to R3 from the data identifiers VR41.

The database system 10 according to this exemplary embodiment can provide the following effects.

The storage area DA0 for the entity data D11 to D43, and the storage areas for the data identifiers VR11 to VR43 uniquely representing the entity data D11 to D43 are completely isolated from each other, whereby it is possible to enhance the efficiency of the updating process of the database 41, improve the processing speed of the searching and summarization, and improve the portability.

More specifically, when updating, adding or deleting is performed in connection with the database 91, the updating process is efficiently performed. For example, in the case where a value of the entity data D41 with variable lengths in the storage area DA0 is updated to be another value, it is only necessary, in accordance with this updating, to update the values of all the data identifiers VR41 in the identifier table RT0 of FIG. 3 and the conversion table in FIG. 5(B) to be new values. In the case where a new tuple is added to the identifier table RT0 and this new tuple only stores the existing data identifiers (for example, data identifiers VR11 to VR14), it is not necessary to update the conversion table of FIG. 5(B). Further, in the case where a part of tuples (for example, tuple of tuple identifier R1) is deleted from the identifier table RT0, it is not always necessary to update the conversion table of FIG. 5(B). As described above, since it is possible to reduce updating of the database 41 as minimum as possible at the time of updating, adding or deleting the entity data, it is possible to efficiently and rapidly perform the updating even in the case where the updating is frequently performed to the database 41.

By using the data structure illustrated in FIG. 5(A) through FIG. 5(C), the database system 10 according to this exemplary embodiment can collectively obtain the groups of tuple identifiers associated with the data identifiers (groups of tuple identifiers stored in the metadata area Fidx), thereby being able to rapidly access the groups of tuples storing common data identifiers in the identifier table RT0. This makes it possible to increase the speed of processing such as searching, summarization and updating of the tuples.

Since the storage area DA0 for the entity data D11 to D43 and the storage areas for the data identifiers VR11 to VR43 are completely isolated from each other, the reference table RT0 and the group of the entity data can be easily arranged in a dispersed manner. For example, it is possible to arrange the reference table RT0 and the group of the entity data dispersely in two computer systems, which are connected with each other through a LAN or other computer networks.

Further, since the storage area DA0 for the entity data D11 to D43 and the storage areas for the data identifiers VR11 to VR43 are completely isolated from each other, the database structure is less likely to depend on the hardware configuration, whereby it is possible to easily port the database structure to the other system.

### First Modification Example of First Exemplary Embodiment

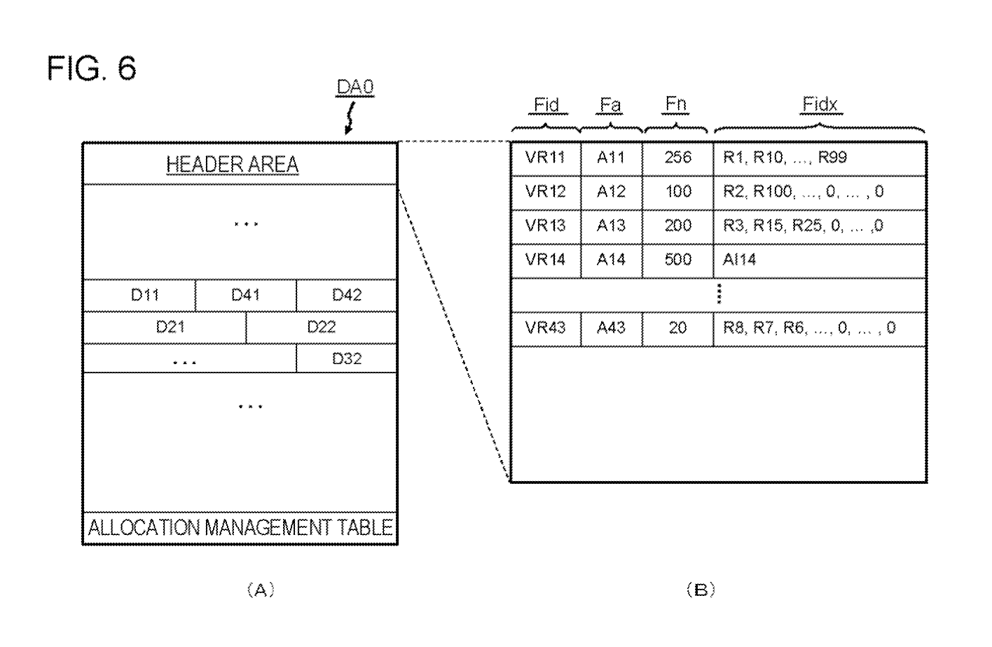

FIG. 6(A) is a schematic view of the storage area DA0, and FIG. 6(B) is a diagram schematically illustrating a first modification example of the conversion table in the storage area DA0 of the database 41 according to the first exemplary embodiment.

As with the conversion table in FIG. 5(B), the conversion table in FIG. 6(B) has the areas Fid for storing the data identifiers VR11 to VR43, and the areas Fa for storing the position data A11 to A43. The position data A11 to A43 are data indicative of the storage areas of the entity data D11 to D43 corresponding to the data identifiers VR11 to VR43.

In the conversion table illustrated in FIG. 6(B), there are provided, for each of the data identifiers VR11 to VR43, a metadata area Fidx for storing a group of tuple identifiers corresponding to the data identifiers VR11 to VR43, and a flag area Fn for storing the number of data stored in each of the metadata areas Fidx (flag information).

In the first modification example, each of the metadata areas Fidx has a fixed length, and can contain 256 tuple identifiers at maximum. In the case where the number of tuple identifiers associated with certain data identifiers exceeds the maximum quantity (256 identifiers), in other words, in the case where the total data amount of the tuple identifiers associated with those data identifiers exceeds the size of the fixed length of the metadata area Fidx thereof, the position data indicative of the position of the storage area (overflow area) storing 500 tuple identifiers or more are stored in the metadata area Fidx. For example, in the conversion table FIG. 6(B), the metadata area Fidx corresponding to the data identifier VR14 stores the position data AI14 indicative of the position of the overflow area storing the tuple identifiers. As the position data AI14, it may be possible to use an address designating the absolute position of the storage area of the tuple identifiers, an offset designating the relative position (effective address) of the storage area, or a pointer indicating an address allocated to the storage area.

With the conversion table illustrated in FIG. 6(B), the total length of the areas Fid, the areas Fa, the flag areas Fn and the metadata areas Fidx can be made a fixed length regardless of the number of tuple identifiers associated with the data identifiers, whereby it is possible to rapidly refer to the predetermined number of the tuple identifiers or lower. This makes it possible to improve the access speed to the group of tuples storing the common data identifiers in the identifier table RT0 illustrated in FIG. 3.

It should be noted that, in this exemplary embodiment, in the case where the number of the tuple identifiers associated with a certain data identifier exceeds the maximum quantity (256 identifiers), all the tuple identifiers are stored in the overflow area, but the exemplary embodiment is not limited to that. In such a case, it may be possible to store a part of the tuple identifiers in the overflow area, and store the remaining tuple identifiers in the metadata area Fidx.

Further, in the case where the number of tuple identifiers associated with the data identifier exceeds the maximum quantity (256 identifiers), it may be possible to store, as the flag information, a one-bit value indicating that the number of tuple identifiers exceeds the maximum quantity in the flag area Fn, in lieu of a multi-bit value indicative of the number of the tuple identifiers.

### Second Modification Example of First Exemplary Embodiment

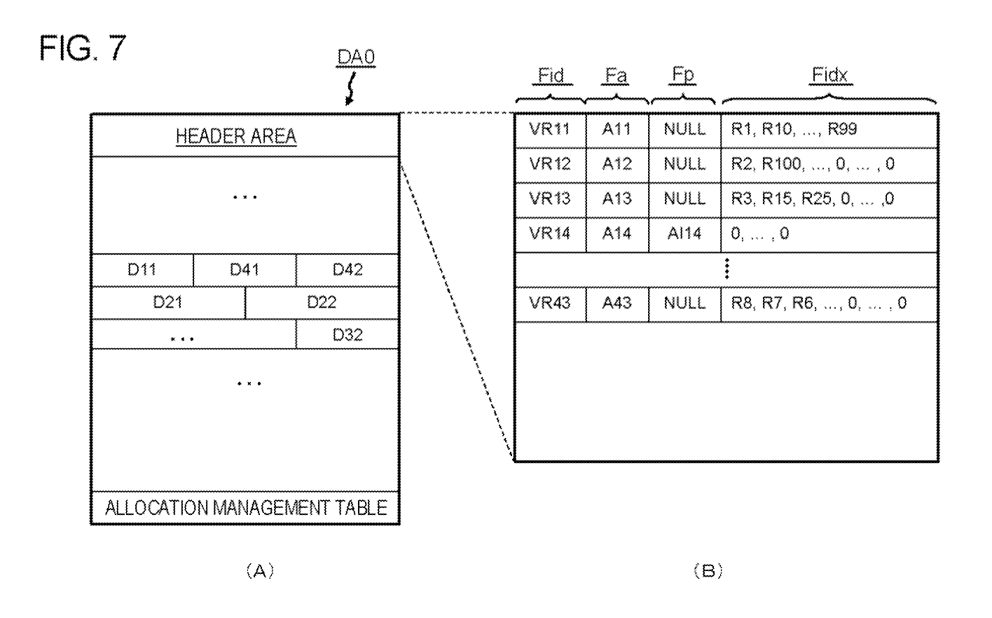

FIG. 7(A) is a schematic view of the storage area DA0, and FIG. 7(B) is a diagram schematically illustrating a second modification example of the conversion table in the storage area DA0 of the database 41 according to the first exemplary embodiment.

As with the conversion table illustrated in FIG. 5(B), the conversion table illustrated in FIG. 7(B) has the areas Fid for storing the data identifiers VR11 to VR43, and the areas Fa for storing the position data A11 to A43 indicative of the position of the storage area for the entity data D11 to D43 each corresponding to the data identifiers VR11 to VR43.

The conversion table illustrated in FIG. 7(B) further has the metadata areas Fidx having a fixed length for storing the groups of tuple identifiers each corresponding to the data identifiers VR11 to VR43, and the flag areas Fp. The flag areas Fp store values indicating whether the number of data stored in each of the metadata areas Fidx exceeds the fixed length of the metadata area Fidx or not (flag information).

In the second modification example, each of the metadata areas Fidx can store, for example, 256 tuple identifiers at maximum. In the case where the number of tuple identifiers associated with certain data identifiers is the maximum quantity (256 identifiers) or lower, a NULL value is stored in the flag area Fp. On the other hand, in the case where the metadata area Fidx stores m tuple identifiers, the m being a value less than the maximum quantity (256 identifiers), the metadata area Fidx stores the m tuple identifiers and (256−m) special values (for example, a value zero). For example, in the conversion table illustrated in FIG. 7(B), the metadata area Fidx corresponding to the data identifier VR13 stores three tuple identifiers R3, R15 and R25, as well as 253 (=256−3) zero-values (=0).

On the other hand, in the case where the number of tuple identifiers associated with the data identifiers exceeds the maximum quantity (256 identifiers), in other words, in the case where the total data amount of tuple identifiers associated with the data identifiers exceeds the size of the fixed length of the metadata area Fidx, the flag area Fp stores the position data indicating the position of the storage area (overflow area) for storing the tuple identifiers. For example, in the conversion table illustrated in FIG. 7(B), the flag area Fp corresponding to the data identifier VR14 stores the position data AI14 indicative of the position of the overflow area that stores the tuple identifier. The metadata area Fidx corresponding to the data identifier VR14 stores 256 zero-values (=0). As the position data VI14, it may be possible to use an address designating the absolute position of the storage area of the tuple identifier, an offset designating the relative position (effective address) of the storage area, or a pointer indicative of an address allocated to the storage area.

With the conversion table illustrated in FIG. 7(B), it is possible to make the total length of the areas Fid, the areas Fa, the flag areas Fp and the metadata areas Fidx have a fixed length regardless of the number of tuple identifiers associated with the data identifiers, whereby it is possible to rapidly refer to the predetermined number of the tuple identifiers or lower. This makes it possible to improve the access speed to the group of tuples storing the common data identifiers in the identifier table RT0 illustrated in FIG. 3.

### Third Modification Example of First Exemplary Embodiment

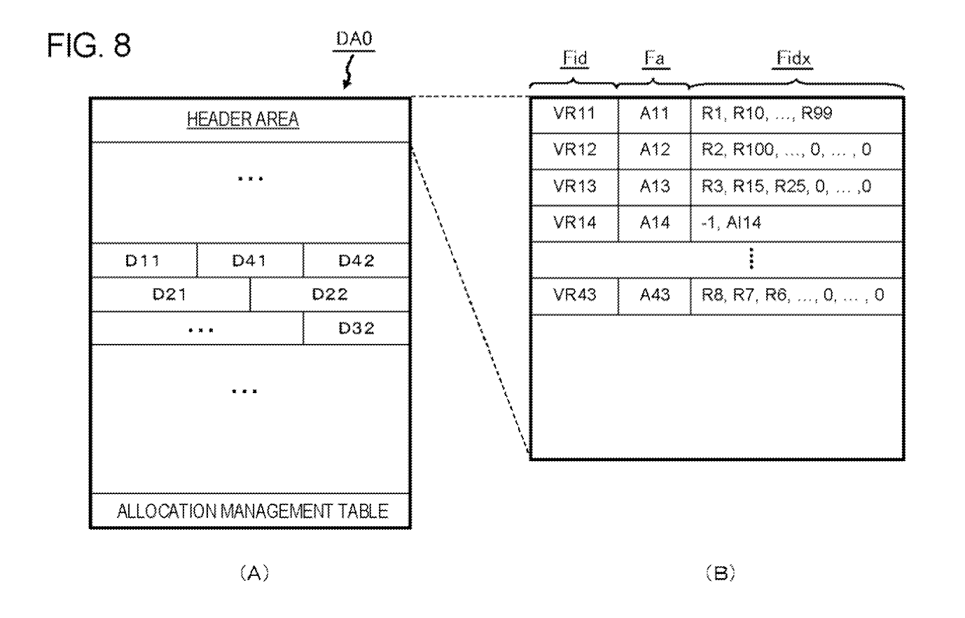

FIG. 8(A) is a schematic view of the storage area DA0, and FIG. 8(B) is a diagram schematically illustrating a third modification example of the conversion table in the storage area DA0 in the database 41 according to the first exemplary embodiment.

As with the conversion table illustrated in FIG. 5(B), the conversion table illustrated in FIG. 8(B) has the areas Fid for storing the data identifiers VR11 to VR43, and the areas Fa for storing the position data A11 to A43 indicative of the positions of the storage areas of the entity data D11 to D43 each corresponding to the data identifiers VR11 to VR43. The conversion table illustrated in FIG. 8(B) further has the metadata areas Fidx having a fixed length for storing the group of tuple identifiers each corresponding to the data identifiers VR11 to VR43.

In the third modification example, each of the metadata areas Fidx can stores, for example, 256 tuple identifiers at maximum. In the case where the number of tuple identifiers associated with data identifiers exceeds the maximum quantity (256 identifiers), in other words, in the case where the total data amount of the tuple identifiers associated with the data identifiers exceeds the size of the fixed length of the metadata area Fidx, the metadata area Fidx stores a special value (for example, a value of “−1”) and the position data indicating the position of the storage area (overflow area) that stores the tuple identifiers.

For example, in the conversion table illustrated in FIG. 8(B), the metadata area Fidx corresponding to the data identifier VR14 stores a value “−1” and the position data AI14 indicating the position of the overflow area. As the position data AI14, it may be possible to use an address designating the absolute position of the storage area storing the tuple identifier, an offset designating the relative position (effective address) of the storage area, or a pointer indicating an address allocated to the storage area.

With the conversion table illustrated in FIG. 8(B), it is possible to make the total length of the areas Fid, the areas Fa and the metadata areas Fidx have a fixed length regardless of the number of tuple identifiers associated with data identifiers, whereby it is possible to rapidly refer to less than predetermined number of the tuple identifiers. This makes it possible to improve the access speed to the group of tuples storing the common data identifiers in the identifier table RT0 illustrated in FIG. 3. Further, the data structure according to the third modification example does not have the flag area Fp, whereby it is possible to realize a simpler structure as compared with the data structure of the second modification example illustrated in FIG. 7.

In the case where the number of tuple identifiers associated with data identifiers exceeds the maximum number (256 identifiers), the metadata area Fidx may store only the value “−1”, rather than storing both the value “−1” and the position data. In such a case, the tuple identifiers are stored in the overflow area prepared in advance so as to correspond to the data identifiers.

### Fourth Modification Example of First Exemplary Embodiment

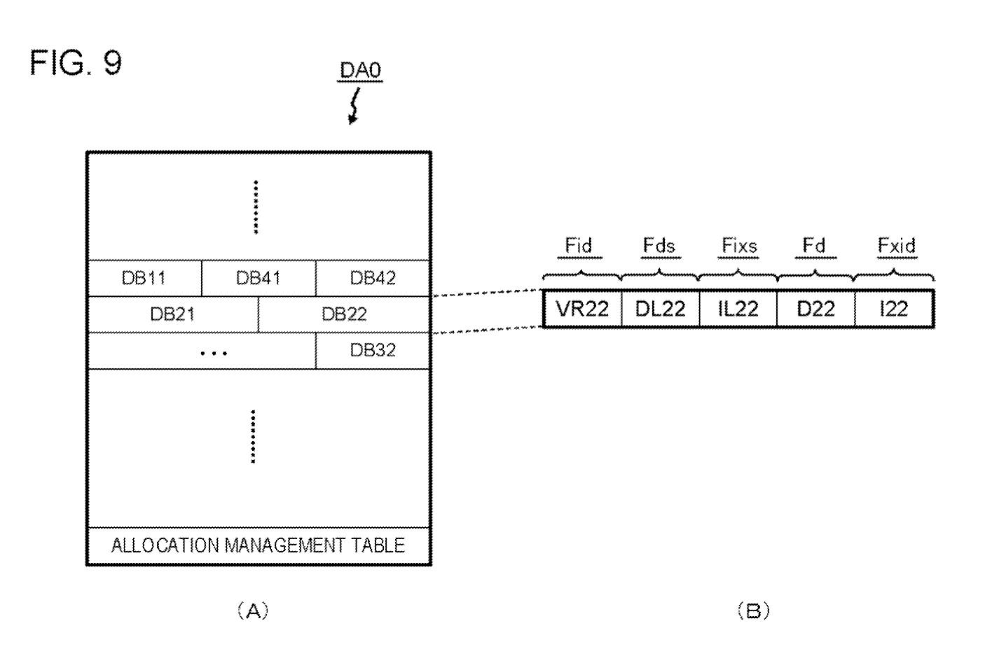

FIG. 9(A) and FIG. 9(B) are diagrams each schematically illustrating a logical data structure according to a fourth modification example of the first exemplary embodiment. In the fourth modification example, the conversion table as used in the first modification example to third modification example is not provided to the storage area DA0. As illustrated in FIG. 9(A), in this modification example, the storage area DA0 stores data blocks DB11 to DB43 each corresponding to the data identifier VR11 to VR43 of the reference table RT0. Each of the data blocks includes a data identifier and an entity data value corresponding to the data identifier, as well as a group of tuple identifiers as index information.

FIG. 9(B) is a diagram schematically illustrating a data structure of a data block DB22. As illustrated in FIG. 9(B), the data block DB 22 has an area Fid for storing the data identifier VR22, a variable length area Fd for storing the entity data D22, a variable length area (metadata area) Fxid for storing a tuple identifier group 122 associated with the data identifier VR22. Further, the data block DB22 has an area Fds for storing a length DL22 of the entity data D22, and an area Fixs for storing a length IL22 of the metadata area Fxid.

According to this modification example, the transaction execution unit 23 can refer to the tuple identifiers associated with the entity data (data identifiers), by looking up the inside of the metadata area Fxid located at the end portion of each of the data blocks DB11 to DB43. Therefore, the database system 10 according to this exemplary embodiment can collectively obtain the groups of tuple identifiers associated with the data identifiers, whereby it is possible to perform the high-speed access to the tuple group storing the common data identifiers in the identifier table RT0. Therefore, it is possible to improve the speed of processing such as searching, summarization and update of the tuple.

### Second Exemplary Embodiment

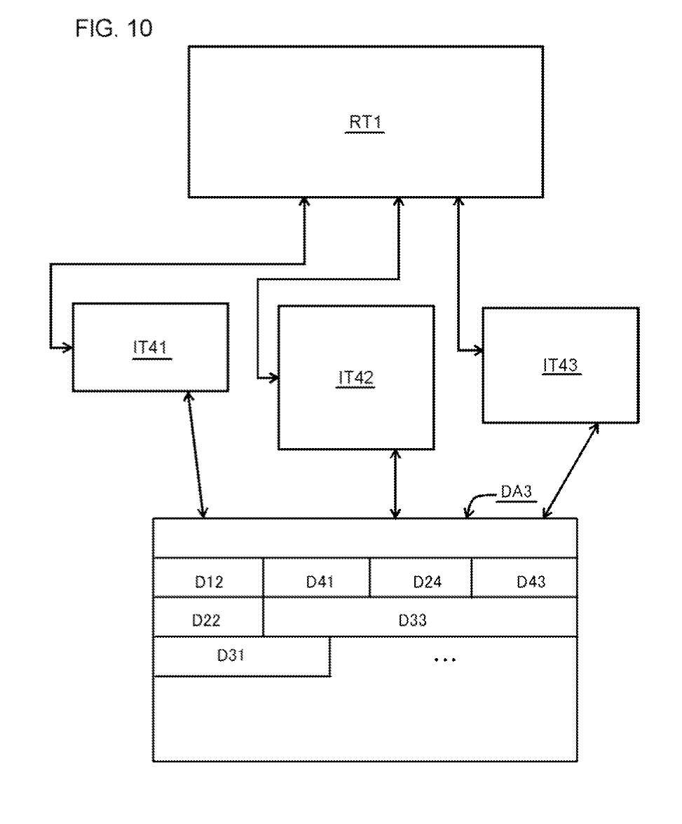

FIG. 10 is a schematic view illustrating a database 41 according to a second exemplary embodiment of the present invention. As illustrated in FIG. 10, the database structure has a group of entity data stored in a storage area DA3 of the storage device 40, and further has a reference table RT1 and a first to third intermediate identifier tables IT41, IT42 and IT43 stored in storage areas, which are different from the storage area DA3.

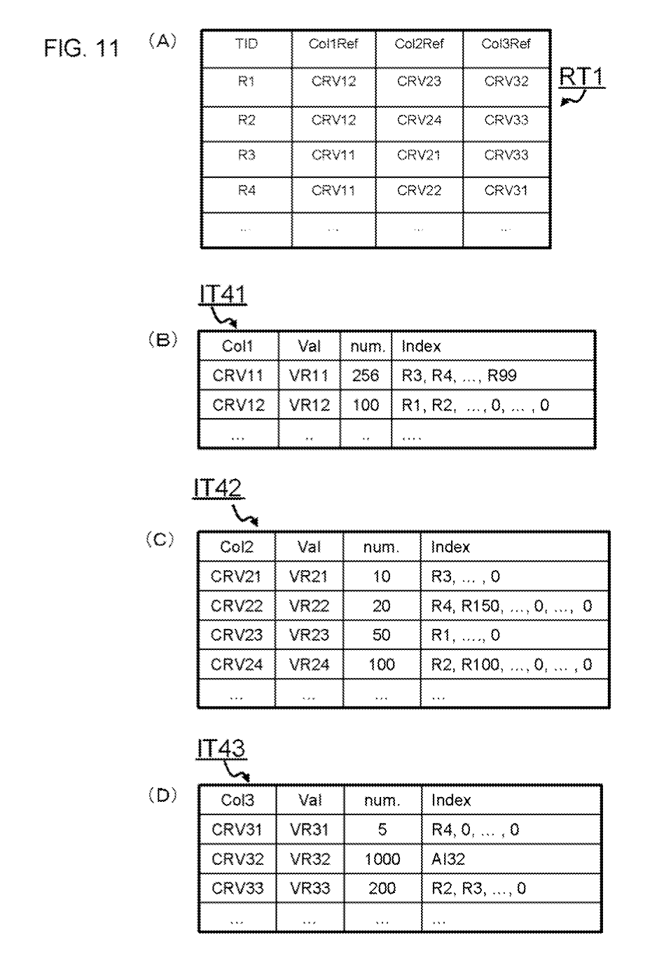

FIG. 11(A) is a diagram illustrating a schematic configuration of the reference table RT1. The reference table RT1 has plural tuples defined in the row direction, and four attribute fields TID, Col1Ref, Col2Ref and Col3Ref defined in the column direction. The number of the tuples in the reference table RT1 may be set, for example, in the range of tens to millions. Further, the number of attribute fields is not limited to four.

Tuple identifiers (TID) R1, R2, R3, R4, . . . are allocated uniquely to tuples in the reference table RT1. Reference identifiers CRV11, CRV12, CRV31, . . . with fixed lengths are each stored in a area defined by the tuple and the attribute field Col1Ref, Col2Ref, Col3Ref (area at which the tuple intersects the attribute field Col1Ref, Col2Ref, Col3Ref). Values of the reference identifiers CRV11 to CRV31 can be obtained by using the hash function as the case with the data identifiers in the first exemplary embodiment. More specifically, the values of the reference identifiers CRV11 to CRV31 can be set to the output values of the hash function, which is output in response to input of the data identifiers VR11 to VR31.

FIG. 11(B) to FIG. 11(D) are diagrams schematically illustrating structures of the first to third intermediate identifier tables IT41, IT42 and IT43. The first intermediate identifier table IT41 has plural tuples defined in the row direction, and four attribute fields Col1, Val, num and Index defined in the column direction. The attribute field Col1 contains the reference identifiers CRV11, CRV12, . . . with fixed lengths, and, the attribute field Va1 contains each of the data identifiers VR11, VR12, . . . with fixed lengths, each of the data identifiers being in an area corresponding to each of the tuples. The attribute field Index contains the tuple identifiers as index information in an area corresponding to the tuples, and the attribute field num contains the number of tuple identifiers contained in each attribute field Index.

The second intermediate identifier table IT42 has plural tuples defined in the row direction, and four attribute fields Col2, Val, num and Index defined in the column direction. The attribute field Col2 contains the reference identifiers CRV21, CRV22, with fixed lengths, and, the attribute field Val contains each of the data identifiers VR21, VR22, . . . with fixed lengths, each of the data identifiers being in an area corresponding to each of the tuples. The attribute field Index contains the tuple identifiers as index information in an area corresponding to the tuples, and the attribute field num contains the number of tuple identifiers contained in each attribute field Index.

The third intermediate identifier table IT43 has plural tuples defined in the row direction, and four attribute fields Col3, Val, num and Index defined in the column direction. The attribute field Col3 contains the reference identifiers CRV31, CRV32, . . . with fixed lengths, and, the attribute field Val contains each of the data identifiers VR31, VR32, . . . with fixed lengths, each of the data identifiers being in an area corresponding to each of the tuples. The attribute field Index contains the tuple identifiers as index information in an area corresponding to the tuples, and the attribute field num contains the number of tuple identifiers contained in each attribute field Index.

Each of the first to third intermediate identifier tables IT41, IT42 and IT43 does not include any reference identifiers whose values overlap with each other, and hence, has a data structure in which redundancy is eliminated. Further, each of the first to third intermediate identifier tables IT41, IT42 and IT43 has the attribute fields num and Index, which respectively correspond to the area Fn and the metadata area Fidx of the conversion table illustrated In FIG. 6(B) of the second exemplary embodiment.

The transaction execution unit 23 searches the reference identifiers CRV11 to CRV33 and the data identifiers VR11 to VR33, thereby being able to access the entity data with variable lengths using the searching results. Since the storage area DA3 has the conversion tables similar to the conversion tables in the first exemplary embodiment and the modification examples thereof, the transaction execution unit 23 can access the entity data on the basis of the searching results.

Further, in this exemplary embodiment, by using the attribute fields num and Index in the first to third intermediate identifier tables IT41 to IT43, it is possible to collectively obtain the groups of tuple identifiers associated with each of the reference identifiers CRV11 to CRV33, whereby it is possible to perform the high-speed access to the tuple groups that store the common reference identifiers in the reference table RT1. This makes it possible to improve the speed of processing such as searching, summarization and updating of tuples.

### Modification Examples of Second Exemplary Embodiment

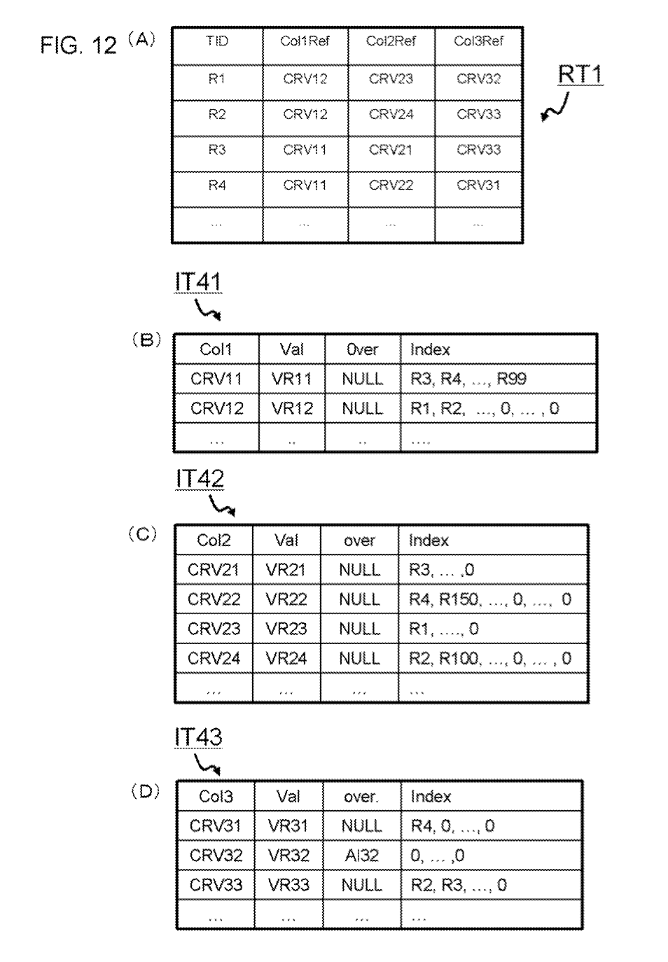

FIG. 12(A) through FIG. 12(D) are diagrams each schematically illustrating a logical data structure according to a modification example of the second exemplary embodiment. FIG. 12(A) is a diagram illustrating a schematic configuration of a reference table RT1, which is the same as that in FIG. 11(A). FIG. 12(B) through FIG. 12(D) are diagrams schematically illustrating data structures of intermediate identifier tables IT41, IT42 and IT43 according to the modification example. Each of the first to third intermediate identification tables IT41 to IT43 according to this modification example has attribute fields Over and Index corresponding to the area Fp and the metadata area Fidx, respectively, of the conversion table (FIG. 7(B)) of the second modification example of the first exemplary embodiment.

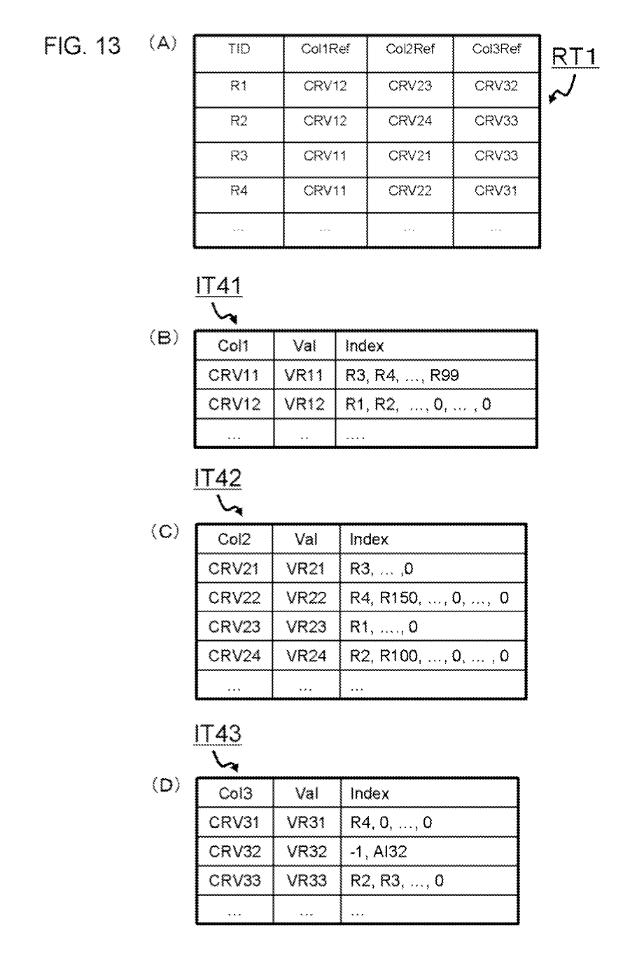

FIG. 13(A) through FIG. 13(D) are diagrams each schematically illustrating a logical data structure according to another modification example of the second exemplary embodiment. FIG. 13(A) is a diagram illustrating a schematic configuration of a reference table RT1, which is the same as that in FIG. 11(A). FIG. 13(B) through FIG. 13(D) are diagrams schematically illustrating data structures of intermediate identifier tables IT41, IT42 and IT43 according to this modification example. Each of the first to third intermediate identification tables IT41 to IT43 according to this modification example has an attribute field Index corresponding to the metadata area Fidx of the conversion table (FIG. 8(B)) of the third modification example of the first exemplary embodiment.

Therefore, with these modification examples, it is possible to collectively obtain the groups of tuple identifiers associated with each of the reference identifiers CRV11 to CRV33, whereby it is possible to perform the high-speed access to the tuple groups that store the common reference identifiers in the reference table RT1. This makes it possible to improve the speed of processing such as searching, summarization and updating of tuples.

The exemplary embodiments of the present invention have been described with reference to the drawings. However, these are merely examples of the present invention, and it may be possible to employ various configurations other than those described above. For example, those exemplary embodiments perform processes suitable for executing transactions to the database 41, but are not limited to that. As described above, the transactions are processes that satisfy the ACID properties. However, it may be possible to apply the database structure according to the present invention to data processing in which not all the ACID properties are satisfied.

In the exemplary embodiments described above, the query receiver 21 receives a query that is described in the query language, and the analysis unit 22 analyzes the received query. However, the present invention is not limited to that. For example, it may be possible that the query is not described in the query language (database language) and simply includes values for calling the application programming interface (API) function for the database.

The present application claims priority based on Japanese Patent Application No. 2009-14142 filed with Japan Patent Office (filing date: Jan. 26, 2009), all of which disclosure is incorporated herein by reference as a part of the present application.

1. A database system comprising:
a data storage unit including a database including a plurality of entity data; and,
a data processing unit that receives a query, and performs, to the database, data processing based on the received query, wherein
the database includes:
an identifier table storing data identifiers each having a fixed length and uniquely representing each of the plurality of entity data in an area specified by at least one tuple defined in a row direction and at least one attribute field defined in a column direction; and
a conversion table showing a correspondent relationship is between the data identifiers and position data each indicating a position of a storage area of each of the plurality of entity data, wherein
the conversion table includes a metadata area for storing a tuple identifier uniquely designating the tuple that stores each of the data identifiers in the identifier table.

2. The database system according to claim 1, wherein
a storage area for the identifier table and a storage area for the entity data are allocated differently from each other.

3. The database system according to claim 1, wherein
a value of each of the data identifiers is a value outputted from a hash function that outputs a bit stream having a fixed length in response to input of the entity data.

4. The database system according to claim 1, wherein
the metadata area has a size of a fixed length.

5. The database system according to claim 4, wherein
the conversion table includes, for each of the data identifiers, a flag area for storing flag information indicating whether or not the data amount of tuple identifiers exceeds a fixed length size of the metadata area.

6. The database system according to claim 4, wherein
the database further includes an overflow area for storing all or a part of the tuple identifiers in the case where the data amount of the tuple identifiers exceeds the fixed length size, and,
the data processing unit stores all or a part of the tuple identifiers into the overflow area in the case where the data amount of the tuple identifiers exceeds the fixed length size.

7. The database system according to claim 6, wherein
the data processing unit stores position data indicating a position of a storage area of the tuple identifier into the metadata area at the time of storing the tuple identifiers into the overflow area.

8. The database system according to claim 7, wherein
the position data indicating the position of the storage area of the tuple identifier is an address designating an absolute position of the storage area of the tuple identifier.

9. The database system according to claim 7, wherein
the position data indicating the position of the storage area of the tuple identifier is an offset designating a relative position of the storage area of the tuple identifier.

10. The database system according to claim 1, wherein
the plurality of entity data include data with variable lengths.

11. The database system according to claim 1, wherein
a plurality of identifier tables is provided,
the database further includes a reference table including a group of reference identifiers each uniquely representing each data identifier in the plurality of identifier tables, and,
the data processing unit performs the data processing using the reference table and the identifier tables.

12. The database system according to claim 1, wherein
the query is described in a query language, and,
the data processing unit analyzes the query, and performs a transaction based on the analyzed result to the database as the data processing.

13. A database structure including a plurality of entity data, comprising:
an identifier table storing data identifiers each having a fixed length and uniquely representing each of the plurality of entity data in an area specified by at least one tuple defined in a row direction and at least one attribute field defined in a column direction; and
a conversion table showing a correspondent relationship between the data identifiers and position data each indicating a position of a storage area of each of the plurality of entity data, wherein
the conversion table includes a metadata area for storing a tuple identifier uniquely designating the tuple that stores each of the data identifiers in the identifier table.

14. The database structure according to claim 13, wherein
a storage area for the identifier table and a storage area for the entity data are allocated differently from each other.

15. The database structure according to claim 13, wherein
the metadata area has a size of a fixed length.

16. The database structure according to claim 15, wherein
the conversion table includes, for each of the data identifiers, a flag area for storing flag information indicating whether or not the data amount of tuple identifiers exceeds a fixed length size of the metadata area.

17. The database structure according to claim 15, further comprising:
an overflow area storing all or a part of the tuple identifiers in the case where the data amount of the tuple identifiers exceeds the fixed length size.

18. A method of managing a database, including:
receiving a query in connection with the database including a plurality of entity data; and,
performing, to the database, data processing based on the received query, wherein
the database includes:
an identifier table storing data identifiers each having a fixed length and uniquely representing each of the plurality of entity data itself in an area specified by at least one tuple defined in a row direction and at least one attribute field defined in a column direction; and
a conversion table showing a correspondent relationship between the data identifiers and position data each indicating a position of a storage area of each of the plurality of entity data, wherein
the conversion table includes a metadata area for storing a tuple identifier uniquely designating the tuple that stores each of the data identifiers in the identifier table.

19. The method of managing a database according to claim 18, wherein
a storage area for the identifier table and a storage area for the entity data are allocated differently from each other.

20. The method of managing a database according to claim 18, wherein
the metadata area has a size of a fixed length.

21. The method of managing a database according to claim 20, wherein
the conversion table includes, for each of the data identifiers, a flag area for storing flag information indicating whether or not the data amount of tuple identifiers exceeds a fixed length size of the metadata area.

22. The method of managing a database according to claim 20, wherein
the database further includes an overflow area for storing all or a part of the tuple identifiers in the case where the data amount of the tuple identifiers exceeds the fixed length size, and,
said performing the data processing includes storing all or a part of the tuple identifiers into the overflow area in the case where the data amount of the tuple identifiers exceeds the fixed length size.

23. The method of managing a database according to claim 22, wherein
said performing the data processing further includes storing position data indicating a position of a storage area of the tuple identifier into the metadata area in the case of storing the tuple identifiers in the overflow area.

24. A computer readable storage medium for storing a computer program that causes a computer to execute a database management process including:
a process that receives a query in connection with a database including a plurality of entity data; and,
a process that performs, to the database, data processing based on the received query, wherein
the database includes:
an identifier table storing data identifiers each having a fixed length and uniquely representing each of the plurality of entity data in an area specified by at least one tuple defined in a row direction and at least one attribute field defined in a column direction; and
a conversion table showing a correspondent relationship between the data identifiers and position data each indicating a position of a storage area of each of the plurality of entity data, wherein
the conversion table includes a metadata area for storing a tuple identifier uniquely designating the tuple that stores each of the data identifiers in the identifier table.

25. The storage medium according to claim 24, wherein
a storage area for the identifier table and a storage area for the entity data are allocated differently from each other.

26. The storage medium according to claim 24, wherein
the metadata area has a size of a fixed length.

27. The storage medium according to claim 26, wherein
the conversion table includes, for each of the data identifiers, a flag area for storing flag information indicating whether or not the data amount of tuple identifiers exceeds a fixed length size of the metadata area.

28. The storage medium according to claim 26, wherein
the database further includes an overflow area for storing all or a part of the tuple identifiers in the case where the data amount of the tuple identifiers exceeds the fixed length size, and,
the data processing includes storing all or a part of the tuple identifiers into the overflow area in the case where the data amount of the tuple identifiers exceeds the fixed length size.

29. The storage medium according to claim 28, wherein
the data processing includes storing position data indicating a position of a storage area of the tuple identifier into the metadata area in the case of storing the tuple identifiers into the overflow area.
